(19) United States
(12) Patent Application Publication
(10) Pub. No.: US 2008/0185913 A1
(43) Pub. Date: Aug. 7, 2008

(54) POWER FEEDING SYSTEM

(75) Inventor: Kazuma Sekiya, Ota-ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/017,188

(22) Filed: Jan. 21, 2008

(30) Foreign Application Priority Data
Feb. 6, 2007 (JP) 2007-26636

(51) Int. Cl. H02J 9/06

(52) U.S. Cl. 307/23

(57) ABSTRACT

A power feeding system which includes an apparatus including a plurality of movable sections supplied with direct current power for operation; and a commercial power source and an auxiliary power source device for supplying electric power to the apparatus. The auxiliary power source device includes an AC/DC converter for converting alternating current power of the commercial power source into direct current power; a storage section for storing the direct current power outputted from the AC/DC converter; a power storage control section for discharging the direct current power stored in the storage means; and a power-feeding control section for supplying, to the movable sections, the direct current power outputted from the AC/DC converter or discharged from the storage section.

### BACKGROUND OF THE INVENTION

1. Field of the Invention

The present invention relates to a power feeding system for normally operating an apparatus even if electric power supplied from a commercial power source is stopped or is insufficient.

2. Description of the Related Art

Various apparatuses are each supplied with electric power from a commercial power source and supplies necessary electric power to various movable sections therein by use of the electric power for normally operating the movable sections. This maintains a function as an apparatus. Accordingly, an apparatus that is not allowed to stop its operation because of stop of power feeding due to power outage or the like is provided with an auxiliary power source device. In case of power outage, the apparatus is prevented from affecting its operation by switching to power feeding from the auxiliary power source device. The auxiliary power source device is configured to store alternating current power from a commercial power source as direct current power and to discharge the direct current power in case of power outage (see Japanese Patent Laid-open No. 2003-87995).

Movable sections constituting each of various apparatuses are classified into a type driven by direct current power and a type driven by alternating current power. Since the commercial electric power is alternating current power, a movable section of the type driven by direct current power may be provided with a function of converting alternating current power into direct current power in some cases. In such a case, when power feeding from the commercial power source is stopped due to power outage or the like and the storage section of the auxiliary power source device supplies electric power to the movable sections, the storage section outputs direct current power. The direct current power thus outputted is converted into alternating current power, supplies it to the movable section, and the alternating current power is again converted into direct current power in the movable section. Thus, there is a problem in that the apparatus is complicated in configuration to be high in price and the power conversion causes a loss uneconomically.

If, like a motor, a movable section is driven in which power consumption is relatively small during operation and relatively large during starting, it is necessary to set the maximum working electric power on the basis of the large power consumption during starting. Also this point is uneconomical. Further, a commercial power source may supply a three-phase, 200-V alternating current, from which a single-phase, 200-V alternating current may be taken out therefrom for use. In such a case, since optional two poles are selectively used, interphase balance is disrupted, which is likely to affect the power source side.

### SUMMARY OF THE INVENTION

It is, therefore, an object of the present invention, to provide a power feeding system that can ensure the normal and stable operation of an apparatus without making the configuration of various apparatuses complicated, in an economical way, if power supply from a commercial power source is cut off or is insufficient.

In accordance with an aspect of the present invention, there is provided a power feeding system including an apparatus including a plurality of movable sections supplied with direct current power for operation; and a commercial power source and an auxiliary power source device for supplying electric power to the apparatus; wherein the auxiliary power source device includes an AC/DC converter for converting alternating current power of the commercial power source into direct current power; a storage section for storing the direct current power outputted from the AC/DC converter; a power storage control section for discharging the direct current power stored in the storage section; and a power-feeding control section for supplying, to the movable sections, the direct current power outputted from the AC/DC converter section or discharged from the storage section.

The storage section can dividedly output direct current power associated with each of the plurality of movable sections having respective operating power sources different from each other. The storage control section has a function that detects a shortage of electric power needed for operation of the movable sections and causes the storage section to discharge electric power to compensate for the shortage with the electric power discharged.

In the present invention, the direct current power outputted from the AC/DC converter section or from the storage section is supplied from the power-feeding section. In any case, the movable sections are operated by the direct current power outputted from the power-feeding control section. It is not necessary to provide a function of converting alternating current into direct current for each of the movable sections. Thus, the normal and stable operation of the apparatuses can economically be ensured without making the configuration of the apparatus complicated. Since the storage section dividedly outputs electrical power associated with the operating power sources of the movable sections, it can deal with the movable sections of different kinds, such as, e.g., a motor operated on AC 100 bolts, an electromagnetic valve operated on DC 24 volts, and a sensor operated on DC 12 volts.

Further, the storage control section has the function that detects a shortage of electric power needed for operation of the movable sections and causes the storage section to discharge electric power to compensate for the shortage with the electric power discharged. Thus, if a movable section in which power consumption during operation is larger than at the time of state is driven, the maximum working electric power is set on the basis of relatively small power consumption encountered during operation and the shortage is compensated for by causing the storage section to discharge, thereby ensuring the necessary electric power.

The above and other object, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a block diagram illustrating the configuration of a power feeding system by way of example;

FIG. 2 is a perspective view of a dicing machine;

FIG. 3 is a perspective view illustrating an internal structure of the dicing machine; and

FIG. 4 is an explanatory diagram illustrating a structure adapted to execute setup.

### DETAILED DESCRIPTION OF THE PREFERRED EMBODIMENTS

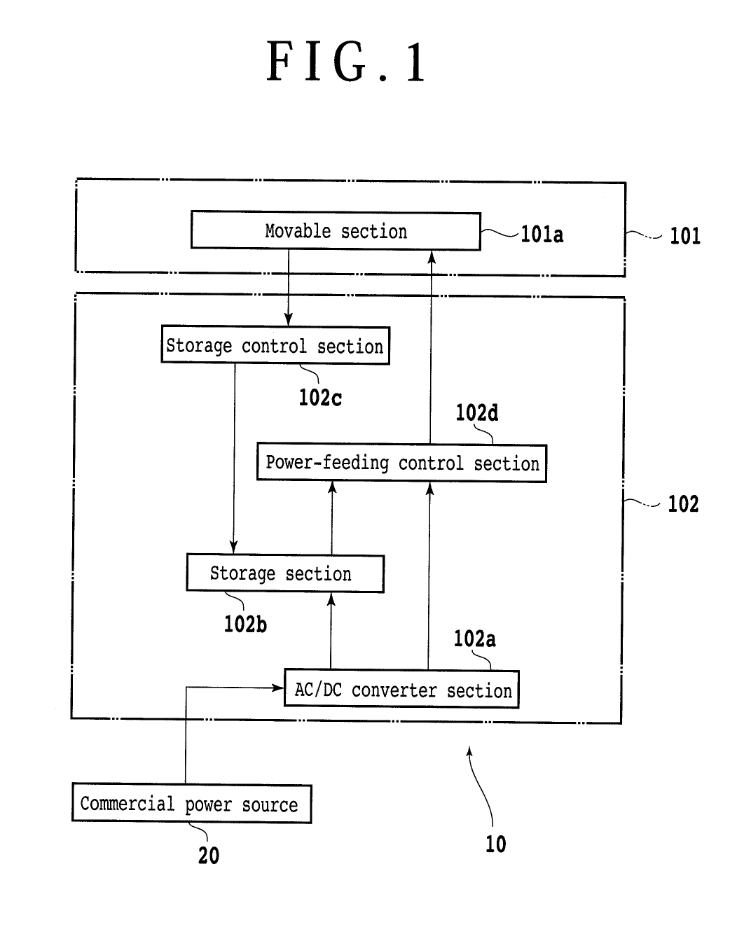

A power feeding system 10 in FIG. 1 includes an apparatus 101 provided with a plurality of movable sections 101a supplied with direct current power for operation; an auxiliary power source device 102 for feeding electrical power to the apparatus 101; and a commercial power source 20. The commercial power source 20 may supply three-phase alternating current or single-phase alternating current. The auxiliary power source device 102 has a function of supplying electric power to the apparatus 101 in place of the commercial power source 20 if supply of electric power from the commercial power source 20 to the apparatus 101 is stopped; and a function of, if electrical power supplied from the commercial power source 20 to the apparatus 101 is insufficient, supplying electrical power compensating for the shortage to the apparatus 101.

The auxiliary power source device 102 includes an AC/DC converter section 102a, a storage section 102b, a storage control section 102c, and a power-feeding control section 102d. The AC/DC converter section 102a converts alternating current power from the commercial electric source to direct current power for output. The storage section 102b stores the direct current power outputted from the AC/DC converter section 102a. The storage control section 102c monitors a state of electrical power supplied to the movable sections 101a and controls the operation of the storage section 102b in response to the state. The power-feeding control section 102d dividedly outputs the electrical power outputted from the AC/DC converter section 102a or the storage section 102b to the plurality of the movable sections 101a.

The movable sections 101a are each operated by direct current power dividedly outputted from the power-feeding control section 101a. The power-feeding control section 102d normally distributes the direct current power outputted from the AC/DC converter section to the movable sections 101a. However, in case of power outage, the storage control section 102c detects the power outage and instructs the storage section 102b to discharge, thereby distributing the direct current power discharged from the storage section 102b. If the storage section 102b has a function of dividedly outputting direct current power matched to the movable sections thereto, the power-feeding control section 102d supplies the distributed power to the associated movable sections as it is.

The storage control section 102c monitors not only power shortage but also whether or not the electric power required for the movable sections 101a is insufficient. If the electric power adapted to operate the movable sections 101a is insufficient, the storage control section 102c instructs the storage section 102b to discharge the electric power corresponding to the shortage. The storage section 102b outputs the electric power corresponding to the shortage and supplies it through the power-feeding control section 102d to a movable section 101a insufficient in electric power.

As described above, the movable sections 101a is supplied with electric power from the power-feeding control section 102d at any time, including the time of power outage and of compensating for electric power. However, the power-feeding control section 102d is normally connected to the AC/DC converter section 102a and to the storage section 102b in parallel relation for power outage. Thus, if electric power is insufficient, the storage control section 102c switches the in-parallel relation to in-series relation to enable compensation for the shortage of electric power. A switching circuit for executing such switching is incorporated in e.g. the power-feeding control section 102d. All the movable sections 101a are operated by the direct current power from the power-feeding control section 102d. In other words, they do not need alternating current power. Thus, although the commercial power source supplies three-phase alternating current with 200 volts, alternating current power taken from optional two poles is not used. In short, it is not necessary to take into account the interphase balance.

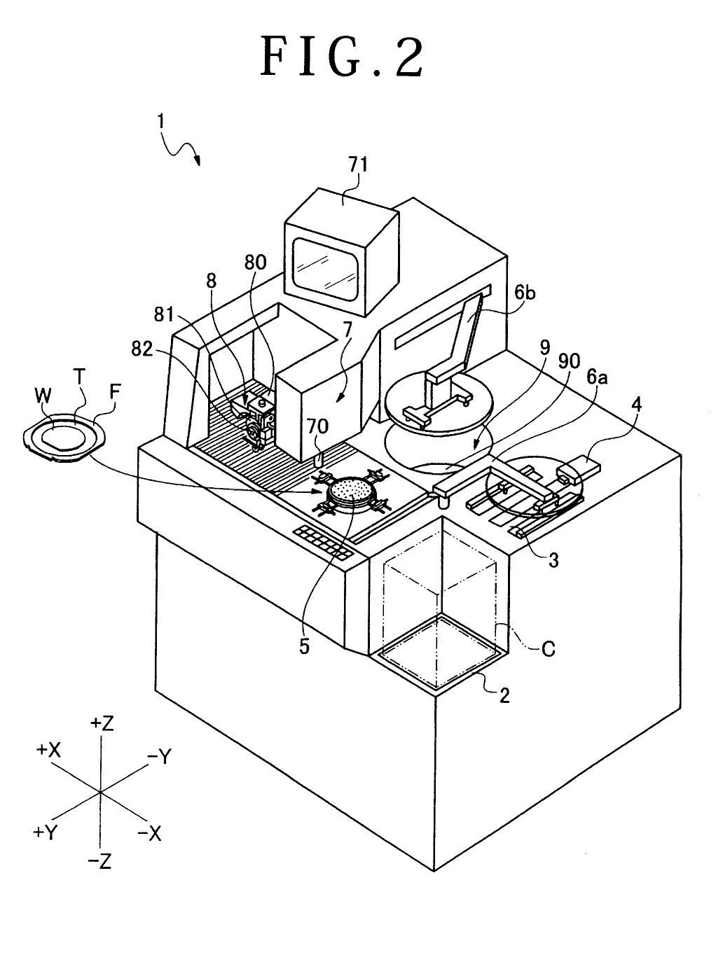

A description is next made of an example in which the present invention is applied to a dicing machine 1 illustrated in FIG. 2. This dicing machine 1 is a machine for cutting and dividing a wafer W into individual chips. The dicing machine 1 includes a wafer cassette placing section 2 on which a wafer cassette C is placed, the wafer cassette C housing wafers W therein; carrying-in and-out means 4 which carries a wafer to be cut from the wafer cassette C to a temporarily placing area 3 and carries a cut wafer in the wafer cassette C; a chuck table 5 which can hold and turn a wafer to be cut and move it in an X-axial direction; and first conveying means 6a which conveys a wafer between the chuck table 5 and the temporarily placing area 3. The dicing machine 1 further includes alignment means 7 which images a front surface of the wafer held by the chuck table 5 and detects an area to be cut; cutting means 8 which cuts the wafer held on the chuck table 5; cleaning means 9 which holds and cleans a cut wafer on a spinner table 90; and second conveying means 6b which conveys a cut wafer from the chuck table 5 to the cleaning means 9.

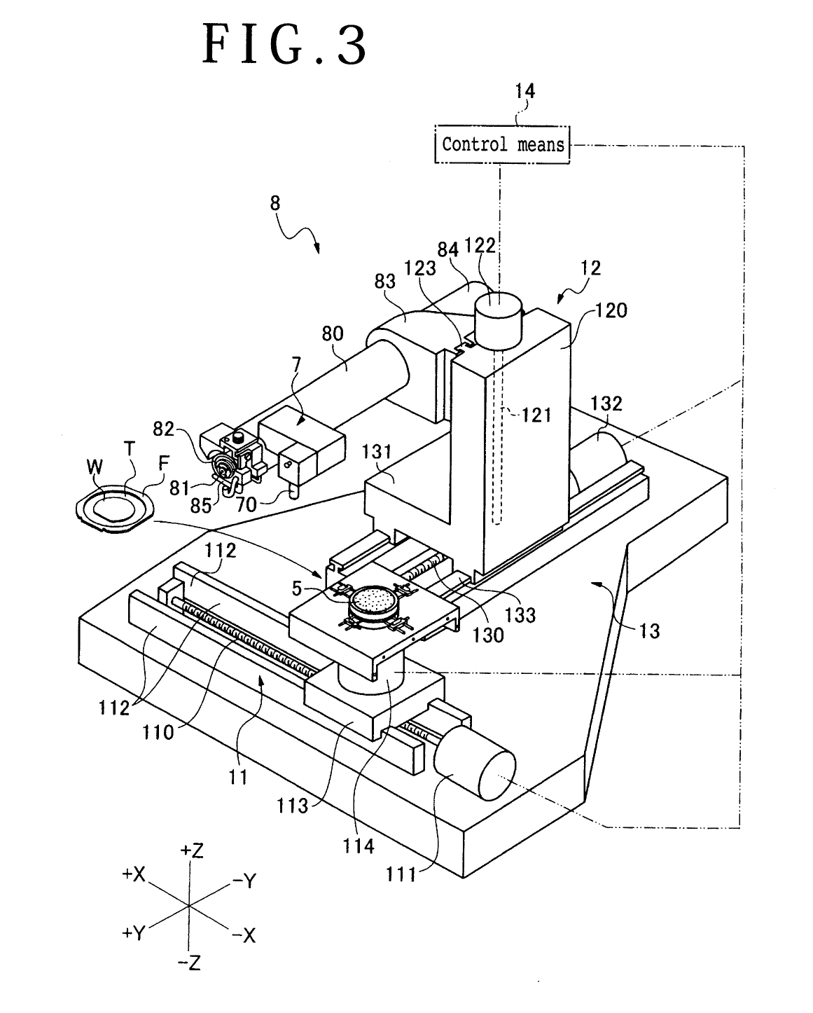

Referring to FIG. 3, the chuck table 5 can be cut-transferred in the X-axial direction by cut-transfer means 11. The cut-transfer means 11 includes a ball screw 110 disposed to extend in the X-axial direction; a servo motor 111 connected to one end of the ball screw 110; a pair of guide rails 112 disposed parallel to the ball screw 110; and a shift base 113 in which an internal nut is threadedly engaged with the ball screw 110 and a lower portion is in slidable contact with the guide rails 112. The ball screw 110 is configured to be driven and turned by the servo motor 111 to move the shift base 113, guided by the guide rails 112, in the X-axial direction and also move the chuck table 5 in the same direction. The servo motor 111 corresponds to the movable section 101a shown in FIG. 1 and its power source voltage is set to e.g. DC 100 volts.

The chuck table 5 is driven and turned by a pulse motor not shown which installed inside a turn drive section 114 secured to top of the shift base 113. This pulse motor corresponds to the movable section 101a shown in FIG. 1 and its power source voltage is set to DC 24 volts.

Cutting means 8 is configured as below. A spindle 81 is rotatably supported by a housing 80. A cutting blade 82 is attached to one end of the spindle 81 and a servo motor 84 is connected to the other end of the spindle 81. The housing 80 is supported by a support portion 83. The spindle 81 and cutting blade 82 are driven and rotated by the servo motor 84. The servo motor 84 corresponds to the movable section 101a shown in FIG. 1 and its power source voltage is set to e.g. DC 100 volts.

Cutting water nozzles 85 which discharge cutting water are disposed to put the cutting blade 82 therebetween. The discharge of cutting water by the cutting water nozzles 85 are controlled by an electromagnetic valve. This electromagnetic valve corresponds to the movable section 101a shown in FIG. 1 and its power source voltage is set to e.g. DC 24 volts.

Alignment means 7 is secured to a lateral portion of the housing 80. The alignment means 7 is provided with an imaging section 70 for imaging a wafer and performs image processing on a picture image obtained by the imaging section 70 to detect a street to be cut. The center of a lens constituting the imaging section 70 is located on the extended line of the cutting blade 82. The picture image obtained by the imaging section 70 is displayed on a monitor 71 shown in FIG. 2. The alignment means 7 and the monitor 71 correspond to the movable sections 101a shown in FIG. 1 and their power source voltage is set to DC 24 volts.

The cutting means 8 and alignment means 7 can be moved in a Z-axial direction by incision-transfer means 12. The incision-transfer means 12 is configured to include a ball screw 121 disposed on one surface of a wall portion 120 so as to extend in the Z-axial direction; a pulse motor 122 for turning the ball screw 121; and guide rails 123 disposed parallel to the ball screw 121. A nut (not shown) inside a support portion 83 is threadedly engaged with the ball screw 12 and the lateral portion of the support portion 83 is in slidable contact with the guide rails 123. As the ball screw 121 is driven and turned by the pulse sensor 122, the support portion 83 is raised and lowered in the Z-axial direction while being guided by the guide rails 123 and also the cutting means 8 supported by the support portion 83 is raised and lowered in the Z-axial direction. The pulse motor 122 corresponds to the movable section 101a shown in FIG. 1 and its power source voltage is set to e.g. 24 volts.

The cutting means 8 and alignment means 7 can be moved in a Y-axial direction by indexing-transfer means 13. The indexing-transfer means 13 is configured to include a ball screw 130 disposed to extend in the Y-axial direction; a shift base 131 formed integrally with the wall portion 120 and provided therein with a nut threadedly engaged with a ball screw 130; a pulse motor 132 for turning the ball screw 130; and guide rails 133 disposed parallel to the ball screw 130. The nut (not shown) inside the shift base 131 is threadedly engaged with the ball screw 130. As the ball screw 130 is driven and turned by the pulse motor 132, the shift base 131, guided by the guide rails 133, is moved in the Y-axial direction to also move the cutting means 8 in the Y-axial direction. The pulse motor 132 corresponds to the movable section 101a shown in FIG. 1 and its power source voltage is set to e.g. DC 24 volts.

The servo motor 111 constituting the cutting-transfer means 11, the pulse motor not shown provided in the turn drive section 114, the pulse motor 122 constituting the incision-transfer means 12, and the pulse motor 132 constituting the indexing-transfer means 13 are controlled by control means 14. The control means 14 is the so-called driver, which corresponds to the movable portion 101a and its power source voltage is set to DC 12 volts.

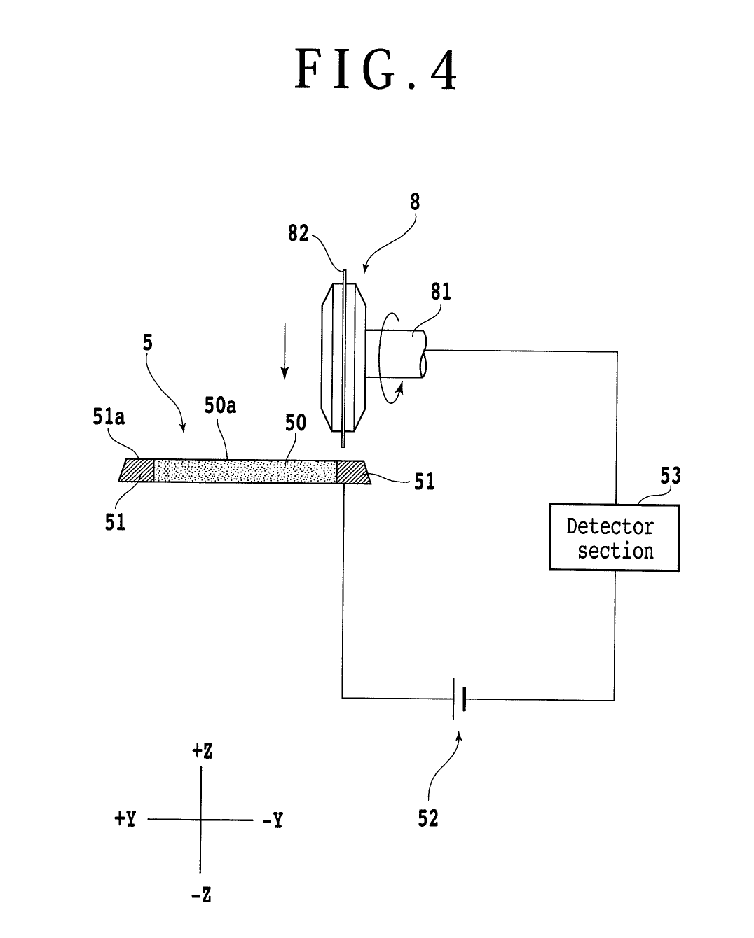

A vertical (Z-axially directional) reference position of the cutting means 8 is initially set as Z-coordinates by work called setup. Referring to FIG. 4, the chuck table 5 is configured such that a suction section 50 having a suction surface 50a adapted to suck a wafer W is enclosed by a conductive frame 51. The suction surface 50a and an upper surface 51a of the frame 51 are formed flush with each other. The frame 51 is connected to the spindle 81 via a DC power source 52 and via a detector section 53. If the cutting blade 82 comes into contact with the frame 51, the spindle 81, the detector section 53 and the cutting blade 82 are brought into conduction with each other via the frame 51. The detector section 53 detects this conduction and recognizes the Z-axially directional position of the cutting means 8 at this time by the number of pulses used to control the pulse motor 122 shown in FIG. 3. The power source 52 and the detector section 53 shown in FIG. 4 correspond to the movable sections 101a shown in FIG. 1 and its power source voltage is set to DC 12 volts.

As shown in FIGS. 2 and 3, the wafer W is housed in the wafer cassette C while being integrally supported by a frame F via a tape T and is carried out therefrom to the temporarily placing area 3 by the carrying-in and -out means 4. Then, the wafer W is conveyed to the chuck table 5 by the first conveying means 6a.

After the wafer W supported by the frame F is held on the chuck table 5, the chuck table 5 is driven by the cutting-transfer means 11 shown in FIG. 3 to move in the X-axial direction, thereby moving the wafer W to a position immediately below the imaging section 70. Then, a to-be-cut street of the wafer W is detected by the alignment means 7 and is aligned with the cutting blade 82.

Thereafter, the chuck table 5 is driven by the cutting-transfer means 11 to further move in the same direction and also the cutting blade 82 driven by the servo motor 84 to rotate at high-speed incises and cuts the to-be-cut street of the wafer W while the cutting means 8 is lowered. While the chuck table 5 is moved in the X-axial direction, the cutting means 8 is indexing-transferred for each interval between streets and sequentially cuts the streets, thus cutting all the same directional streets. Further, after the chuck table 5 is turned by 90 degrees, the same cutting is performed, whereby all the streets are cut lengthwise and widthwise and divided into individual chips.

The servo motor 84, the servo motor 111, the pulse motor 122 and the pulse motor 132 shown in FIG. 3 are operated during the cutting. If they stop, the wafer W may be likely to be damaged. However, in case of power outage, the power-feeding control section 102d shown in FIG. 1 outputs direct current power matched to the power source voltage of the movable sections. Thus, cutting work will not be stopped.

The rotation of the various motors needs larger electric power during starting than during operation. For example, if power consumption is 4 kVA during starting and 1.5 kVA during operation, working electric power is set on the assumption that an electrical power of 4 kVA is normally needed. However, since the motors can be supplied with the electrical power compensating for the shortage from the power-feeding control section 102d, for example, the setting of 2 kVA is economically enough.

After divided into chips, the wafer W is conveyed to the cleaning means 9 by the second conveying means 6b in the state where all the chips are stuck to the tape T to maintain the shape of the wafer as a whole. The plurality of chips which are supported on the frame F with the shape of the wafer W maintained are held on the spinner table 90. When the spinner table 90 is driven and rotated by a servo motor not shown, cleaning water is jetted to the chips to remove cutting scraps stuck thereto due to the cutting. After the cleaning, while the spinner table 90 is rotated, high-pressurized air is directed and jetted to the chips for drying them. The servo motor rotating the spinner table 90 corresponds to the movable section 101a shown in FIG. 1 and its power source voltage is set to e.g. DC 100 volts. Respective electromagnetic valves used to jet the cleaning water and high-pressurized air correspond to the movable sections 101a shown in FIG. 1 and its power source voltage is set to e.g. DC 24 volts.

Even if power outage or the like occurs during the cleaning or drying of the wafer, the cleaning and drying will not be stopped because the direct current power matched to the power source voltage of the movable portions is outputted thereto from the power-feeding control section 102d shown in FIG. 1.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A power feeding system comprising:
an apparatus including a plurality of movable sections supplied with direct current power for operation; and
a commercial power source and an auxiliary power source device for supplying electric power to the apparatus;
wherein the auxiliary power source device includes
an AC/DC converter for converting alternating current power of the commercial power source into direct current power,
storage means for storing the direct current power outputted from the AC/DC converter,
power storage control means for discharging the direct current power stored in the storage means, and
power-feeding control means for supplying, to the movable sections, the direct current power outputted from the AC/DC converter or discharged from the storage means.

2. The power feeding system according to claim 1, wherein the storage means dividedly outputs direct current power associated with each of the plurality of movable sections having respective operating power sources different from each other.

3. The power feeding system according to claim 1, wherein the storage control means has a function that detects a shortage of electric power needed for operation of the movable sections and causes the storage means to discharge electric power to compensate for the shortage with the electric power discharged.
